(19) United States
(12) Patent Application Publication
(10) Pub. No.: US 2007/0257510 A1
(43) Pub. Date: Nov. 8, 2007

(54) DRIVE ARRANGEMENT FOR MOTORIZED MOVEMENT OF A CLOSURE ELEMENT OF A MOTOR VEHICLE

(75) Inventor: Checrallah KACHOUH, Dortmund (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/685,273

(22) Filed: Mar. 13, 2007

(30) Foreign Application Priority Data
Mar. 13, 2006 (DE) 20 2006 004 059.5

(51) Int. Cl. B60J 5/06

(52) U.S. Cl. 296/155

(57) ABSTRACT

A drive arrangement for motorized movement of a closure element of a motor vehicle that can be moved between an open position and a closed position, there being at least one drive which is coupled by drive engineering to the closure element, the drive having a drive motor and a drive line connected downstream of the drive motor. A slotted link mechanism is connected to the drive line of the drive, the slotted link mechanism having a drive element and a driven element, the drive element being be rotated by the drive motor around a drive axis, the drive element engaging the driven element by drive engineering via a control link. A driver corresponds to the control link and by turning the drive element, the driven element can be moved essentially perpendicular to the drive axis.

### BACKGROUND OF THE INVENTION

1. Field of the Invention

This invention relates to a drive arrangement for motorized movement of a closure element of a motor vehicle in which the closure element can be moved between an open position and a closed position, there being at least one drive which is coupled by drive engineering to the closure element, the drive having a drive motor and a drive line connected downstream of the drive motor.

2. Description of Related Art

The concept of a “closure element” of a motor vehicle should be understood comprehensively here. It includes tailgates, rear hatches, hoods, side doors, sliding doors, lifting roofs, sliding windows, etc.

The closure element under consideration is assigned to the opening in the body of the motor vehicle and can be moved between an open position and a closed position. For motorized movement of the closure element, especially in the regions of the tailgates and rear covers of motor vehicles, numerous solutions have become known.

The known drive arrangement (German Patent DE 199 34 629 C2) underlying the invention is used for motorized movement of the rear hatch of a motor vehicle. There is a drive which is coupled by drive engineering to the rear hatch and which has a drive motor and a drive line connected downstream of the drive motor. The drive line here is comprised essentially of a crank and a connecting rod which is coupled, on the one hand, to the crank, and to the rear hatch, on the other hand. The crank together with the connecting rod forms a crank mechanism with a transmission ratio which depends on the respective position of the crank.

A variable transmission ratio is fundamentally desirable in order to be able to easily ensure optimum behavior of the drive force. In a crank mechanism, the transmission ratio viewed via the position of the crank always changes sinusoidally; in certain applications, this is disadvantageous. The drive cannot be optimally matched to the respective application by this defined relationship when using a crank mechanism.

Another known possibility for implementing the drive arrangement is shown by German Patent Application DE 101 17 935 A1 and U.S. Patent Application Publication 2004/0090083 A1. Here, there is a drive with a drive motor and a drive line connected downstream, the drive line having a spindle-feed nut gearing. A variable transmission ratio tailored to the specific application is only possible here with great construction effort using a ball roller spindle.

Finally, reference is made to the known drive arrangement for motorized movement of the sliding door of a motor vehicle, in which there is a spindle with a spindle thread in which a pin-shaped driver runs (German European Patent Translation DE 693 25 371 T2; U.S. Pat. No. 5,341,598). This driver is a component of the feed nut which is guided lengthwise in the direction of the spindle axis. In certain applications, problems can arise with respect to the required installation space with this arrangement.

### SUMMARY OF THE INVENTION

A primary object of the invention is to embody and develop the known drive arrangement such that optimum design of the drive for all applications is possible, especially with respect to the transmission ratio and the required installation space.

The aforementioned object is achieved in a drive arrangement of the initially mentioned type wherein a slotted link mechanism is connected to the drive line of the drive, wherein the slotted link mechanism has a drive element and a driven element, wherein the drive element is rotatable by means of the drive motor around a drive axis, wherein the drive element engages the driven element by drive engineering via a control link and a driver which corresponds to the control link, and wherein the driven element is movable essentially perpendicular to the drive axis by rotation of the drive element.

First of all, it is important that the use of a slotted link mechanism in the drive line of the drive ensures quite special degrees of freedom in the layout of the transmission ratio. For this purpose, a drive element engages a driven element by drive engineering via a control link and a driver corresponding to the control link. The behavior of the transmission ratio via the position of the driving element or driven element can be varied within wide ranges by the corresponding configuration of the control link.

The drive element can be turned around a drive axis here. By rotating the drive element, the driven element can be moved essentially perpendicularly to the drive axis. In this connection, the driven element can be guided lengthwise or can be pivotally supported. This is explained below. An especially compact arrangement can be achieved by moving the driven element essentially perpendicularly to the drive axis.

There are two preferred embodiments for the basic structure of the slotted link mechanism.

In the preferred configuration, the control link is assigned to the drive element and the driver is assigned to the driven element. This means that the control link is driven by means of the drive motor. The driven element with the driver can be guided lengthwise or can be made as a pivoting lever which can be pivoted around the driven axis.

One especially compact and at the same time durable construction can be implemented by the preferred configuration in which the drive element is disk-shaped and has a control link on one end. This applies especially when a flat construction is desired.

The second possibility for the basic structure of the slotted link mechanism consists in that the control link is assigned to the driven element and the driver is assigned to the drive element. Then, it will be preferably provided that the driver is located eccentrically on the drive element. The driven element in the preferred embodiment is made as a pivoting lever which can be pivoted around the driven axle, the control link being located in or on the pivoting lever.

According to another teaching which likewise acquires independent importance, the aforementioned object is achieved in the drive arrangement of the initially mentioned by a slotted link mechanism being connected to the drive line of the drive, wherein the slotted link mechanism has a drive element and a driven element, wherein the drive element is rotatable by means of the drive motor around a drive axis, wherein the drive element engages the driven element by drive engineering via a control link and a driver which corresponds to the control link and wherein the driven element is a pivoting lever which can be pivoted around a driven axis.

In this case, it has been recognized that the configuration of the driven element as a pivoting lever which can be pivoted around the driven axle can be advantageous especially with respect to the required installation space.

All versions which are explained here and which are conceivable for the above described teaching can be applied to the further teaching to the extent they allow pivoting of the driven element. It is pointed out expressly that the movability of the driven element perpendicular to the drive axis is not important here.

In one especially preferred configuration, it is provided that the drive element is roll-shaped and has a control link on its outer periphery. This can entail special advantages with respect to the use of existing installation space.

The invention is explained in detailed below with reference to the accompanying drawings.

### BRIEF DESCRIPTION OF THE DRAWINGS

FIG. 1 is a side view of the rear of a motor vehicle with a drive arrangement in accordance the invention with the tailgate opened,

FIG. 2 is a plan view of a drive of the drive arrangement shown in FIG. 1 with a slotted link mechanism with the tailgate completely opened,

FIG. 3 shows three embodiments of the control link of the slotted link mechanism shown in FIG. 2,

FIG. 4 shows another embodiment of a slotted link mechanism in accordance with the invention,

FIG. 5 is an elevational view of another embodiment of a slotted link mechanism in accordance with the invention and a sectional view of the detail thereof taken along line V-V, and

FIG. 6 shows another embodiment of a slotted link mechanism in accordance with the invention.

### DETAILED DESCRIPTION OF THE INVENTION

The drive arrangement in accordance with the invention is explained below using a closure element 1 in the form of a tailgate 1. However, this should not be understood in a limiting manner. In accordance with the invention, the term “closure element” is intended to encompass all types of closures as are mentioned in the second paragraph of this specification.

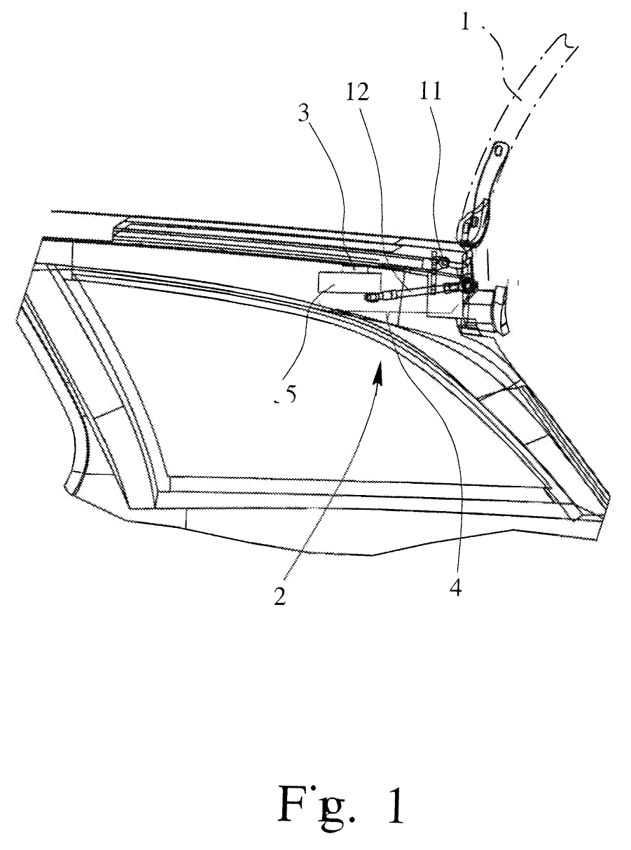

FIG. 1 shows a drive arrangement for motorized movement of the tailgate 1 of a motor vehicle, the tailgate 1 being movable between the illustrated open position and the closed position (not shown). For this purpose, there is at least one drive 2 coupled by drive engineering to the rear hatch 1. For the case in which there is only a single drive 2, it is generally located in the middle viewed in the direction of the transverse axis of the motor vehicle.

To prevent distortion of the tailgate 1, it is preferably provided that there are two drives 2 located laterally on opposite sides of the lengthwise axis of the motor vehicle. The drive or drives 2 can be located on the body of the motor vehicle or on the tailgate 1.

It is pointed out that all statements made below regarding the tailgate 1 can also be applied to all other types of the closure elements 1 under consideration.

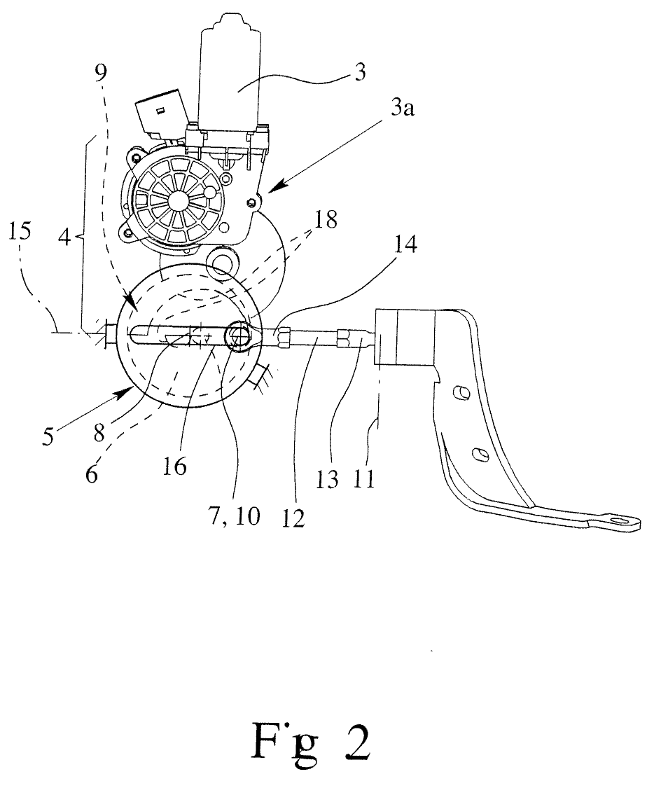

FIG. 2 shows the structure of the drive 2. The drive 2 has a drive motor 3 and a drive line 4 connected downstream of the drive motor 3. The drive line 4, to some extent, establishes the drive-engineering coupling between the drive motor 3 and the tailgate 1 and the body of the motor vehicle. It can also be provided that the drive 2 has a drive motor 3 and several, preferably two, drive lines 4, the force being applied preferably on the two sides of the tailgate 1. In this way, twisting of the tailgate 1 can again be counteracted.

It is important at this point that a slotted link mechanism 5 is connected to the drive line 4 of the drive 2. The slotted link mechanism 5 has a drive element 6 and a driven element 7, the drive element 6 being pivotable around the drive axis 8 by means of the drive motor 3. The drive element 6 engages by drive engineering the driven element 7 via a control link 9 and a driver 10 which corresponds to the control link 9.

By turning the drive element 6 the driven element 7 can be moved essentially perpendicular to the drive axis 8. In particular, this is explained below. However, in all embodiments, it is such that the running of the driver 10 in the control link 9 in the manner of a slotted link mechanism causes relative motion between the drive element 6 and the driven element 7.

A series of possibilities are conceivable for how the drive 2 can interact with the closure element 1 which, here, is the tailgate 1. In a preferred configuration, the closure element 1 is coupled to the body of the motor vehicle to be able to pivot around a closure element axis 11. In this case, a connecting rod 12 is preferably connected to the drive line 4 and on an end 13 is coupled eccentrically to the closure element 1 or to the body of the motor vehicle, the connecting rod 12 being furthermore preferably coupled on its other end 14 to the driven element 7. However, fundamentally, it can also be such that other transmission elements and/or mechanisms are connected between the connecting rod 12 and the driven element 7.

In the general part of the specification it was explained that there are two possibilities for the fundamental structure of the slotted link mechanism 5.

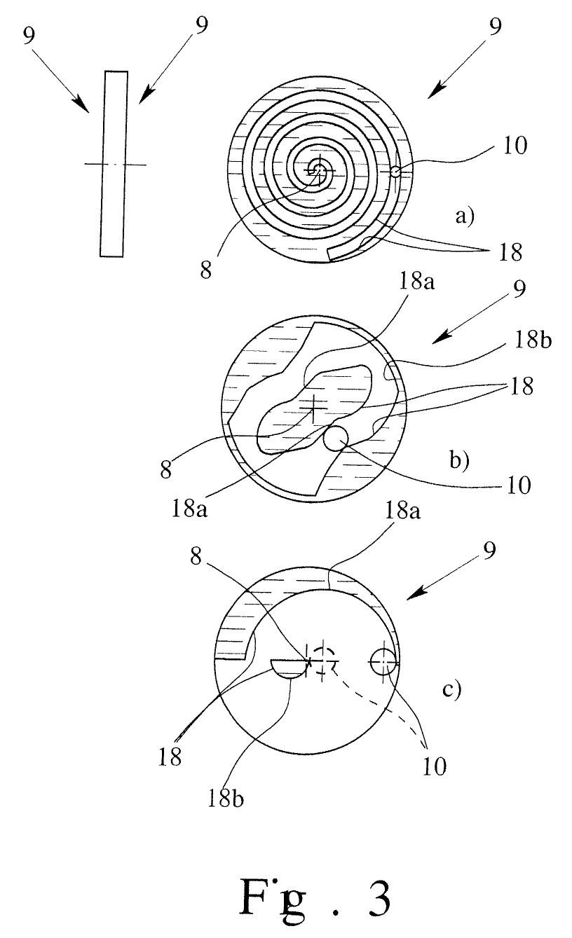

FIG. 2 shows one preferred version in which the control link 9 is assigned to the drive element 6 and the driver 10 is assigned to the driven element 7. The control link 9 can be therefore be turned by means of the drive motor 3 around the drive axis 8; this leads to the driver 10 running in the control link 9 and being displaced accordingly. The control link 9 used in FIG. 2 is shown in FIG. 3c.

In the preferred embodiment shown in FIG. 2, the driven element 7 is guided in a lengthwise direction with the driver 10, preferably the lengthwise axis 15 of the lengthwise guide 16 running perpendicular to the drive axis 8 and intersecting the drive axis 8 in a further preferred configuration.

The lengthwise guide 16 is implemented here by a slot in the stationary sheet metal which, at the same time, forms the cover for the control link 9. The lengthwise guide 16 is therefore a sliding guide. Other configurations are also possible. The driven element 7, in the embodiment shown in FIG. 2, forms a one-piece component with the driver 10. The driven element 7 is coupled here to the connecting rod 12 via a ball joint or the like.

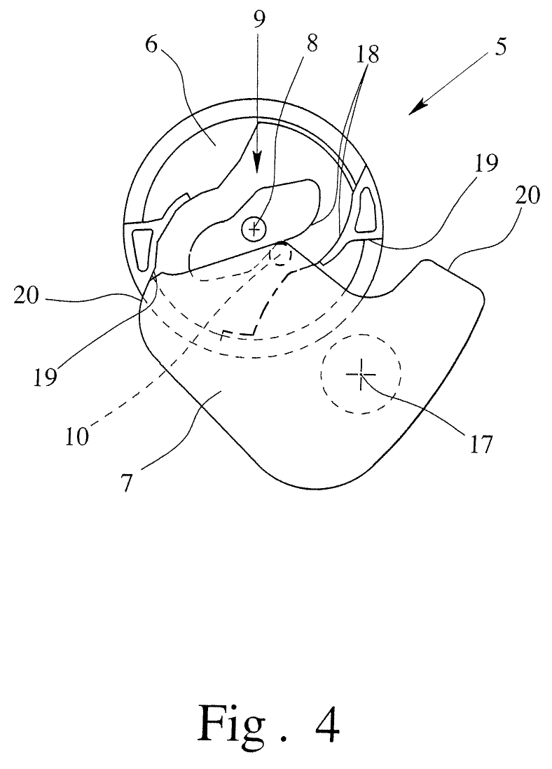

In the preferred embodiment shown in FIG. 4, the driven element 7 is made as a pivoting lever which can be pivoted around the driven axis 17, the driver 10 being located spaced apart from the driven axis 17 on the driven element 7. The driven element 7 can be again coupled to the rear hatch 1 via a connecting rod 12 or the like. This is not shown here. The control link 9 used in the embodiment shown in FIG. 4 is shown in FIG. 3b.

FIG. 4 shows that the driven axis 17 is aligned essentially parallel to the drive axis 8. Thus, the movement of the driven element 7 essentially perpendicular to the drive axis 8 can be ensured.

The drive element 6 is preferably made disk-shaped, the control link 9 being located on the end side of the drive element 6.

Fundamentally, it can also be provided that the control link 9 is located on two sides of the disk-shaped drive element 6. For example, in this way, the force required for guidance of the driver 10 can be distributed between the two sides of the drive element 6. Then, the partial link on one side is essentially identical to the partial link on the other side. This configuration is shown by way of example in FIG. 3a.

However, it can also be advantageous to make the two partial links different. In another preferred embodiment, it is provided that the driver 10 engages the partial link of one side in the opening process and the partial link of the other side in the closing process. Thus, a quite defined closing and opening characteristic can be implemented.

Another preferred configuration relates to a drive 2 with two drive lines 4. Here again, there is a disk-shaped drive element 6 with a partial link on each of sides. In any case, there are two drivers 10 which are each assigned to a respective drive line 4. For example, one partial slot is assigned to one side of the tailgate 1 and the other partial slot to the other side of the tailgate 1. The two partial slots are preferably made identical.

FIG. 3 shows three preferred configurations for the control link 9. In this connection, the crosshatched regions are elevated viewed perpendicular to the plane of the drawings, by which the control surfaces 18 of the control link 9 are formed. The driver 10 which is shown circular in cross section in FIG. 3 is moved accordingly by engaging the control surfaces 18.

According to FIG. 3a, the control link 9 is made essentially helical around the drive axis 8. Depending on the design of the spirals of the control link 9, the transmission ratio of the slotted link mechanism 5 can be set depending on the angle of rotation. In this embodiment of the control link 9, it can be provided that the movement of the closure element 1 between the open position and the closed position requires several revolutions of the drive element 6.

FIG. 3b shows a preferred embodiment in which the control link 9 is made point-symmetrical with respect to the drive axis 8. In this way, certain sections of the control link 9 can be periodically repeated around the drive axis 8; this entails advantages still to be explained.

The control link 9 shown in FIG. 3c is especially well suited for closing elements 1, especially tailgates 1, with two different pivoting regions, the two pivoting regions bordering one another over the path of movement of the tailgate. For example, when the tailgate 1 is opened, first of all, the first pivoting region is traversed in which the weight of the tailgate 1 prevails over the pretensioning of the tailgate 1 which acts in the opening direction. After the transition from the first pivoting region into the second pivoting region, the pretensioning of the tailgate 1 prevails over its weight, by which the tailgate 1 automatically carries out the opening process.

In the aforementioned design of the tailgate 1 with two pivoting regions, it is necessary for motorized movement of the tailgate 1 from the closed position into the open position in the first pivoting region to drive the adjustment motion of the tailgate 1 and in the second pivoting region it is necessary to brake the adjustment motion of the tailgate 1. These boundary conditions are satisfied by the control link 9 shown in FIG. 3c. When the control link 9 is turned around to the right in FIG. 3, the driver 10 runs along the control surface 18a, by which the tailgate 1 is moved in the direction of the open position through the first pivoting region. After rotation of the control link 9 by roughly 180°, the tailgate 1 passes into the second pivoting region, by which the driver 10 drops onto the second control surface 18b. As the control link 9 continues to turn, the tailgate 1 finally reaches the open position and the driver 10 reaches the position shown by the broken line in FIG. 3c.

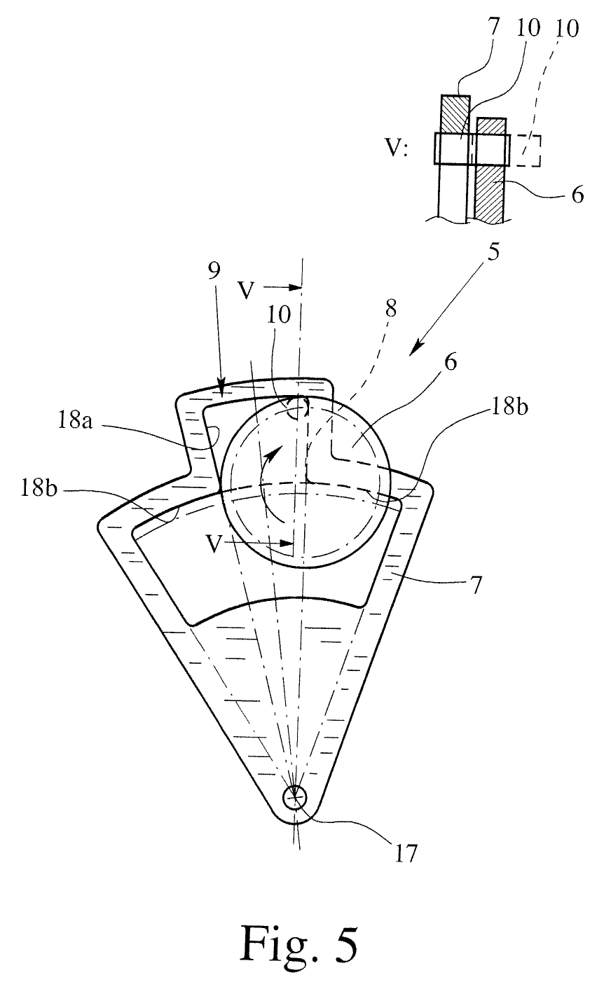

The other fundamental structure of the slotted link mechanism 5 is shown in FIG. 5. Here, the control link 9 is assigned to the driven element 7 and the driver 10 is assigned to the drive element 6. In this connection, the driver 10 is located preferably eccentrically on the drive element 6.

In the preferred embodiment shown in FIG. 5, the driven element 7 is, again, a pivoting lever which can be pivoted around the driven axis 17, the control link 9 being located in or on the pivoting lever 7. Here, it is preferably such that the driven axis 17 is aligned essentially parallel to the drive axis 8. Especially in terms of production engineering, it is advantageous if the control link 9 is a recess in the driven element 7 which is made as a pivoting lever.

For implementation of drive-engineering engagement between the control link 9 and the driver 10, regardless of the fundamental structure of the slotted link mechanism 5, a series of possibilities is conceivable. The control link 9 can be made as a crosspiece, a groove, a recess or a slot on or in the link body. The configuration as a groove is shown by FIG. 3a. The configuration as a recess is shown by FIGS. 3b, 3c & 5.

In the simplest configuration, the driver 10 is made as a driver pin. The arrangements shown in FIGS. 3-5 show such a driver 10 made as a driver pin. Fundamentally, however, it can also be provided that the control link 9, as explained above, is a crosspiece or the like on which a driver 10 made as a carriage runs. The driver 10 is then equipped with the corresponding rollers on one or both sides of the crosspiece. However, the driver 10 can also be a driver pin made as an individual roller. The driver pin is then simply pivotally supported.

Ultimately, the driver 10 engages the control link 9 in either a sliding or rolling manner. In the case of sliding engagement, suitable material pairing between the driver 10, on the one hand, and the control surface 18 of the control link 9, on the other hand, must be observed.

In addition to the described motorized movement of the closing element 1, generally, also manual movement is required. In this connection, it is advantageous if the control link 9 is made such that manual movement of the closure element 1 or the tailgate 1 from the open position into the closed position, or the other way around, without movement of the drive element 6 is possible. This is shown, for example, in FIGS. 4 & 5.

For the configuration shown in FIG. 4, the driven element 7 can be moved around to the left without the drive element 6 being moved. For this purpose, in the control link 9, there is a corresponding undercut. The same applies to the arrangement shown in FIG. 5. The driven element 7 can be likewise moved back and forth out of one of the end positions without likewise moving the drive element 6. In this configuration of the control link 9, a clutch for manual actuation can be completely omitted.

Depending on the application, it can also be advantageous for manual movement of the closure element 1 to be possible without moving the drive element 6 out of the intermediate position. This can be achieved, for example, with the control link 9 shown in FIG. 3c.

A manual actuation capacity can be implemented especially easily when the drive motor 3 with the drive line 4 connected downstream is not completely self-locking. Then, it can be provided that manual application of force to the closure element 1 leads to resetting of the drive element 6 and the drive motor 3. Preferably, at the same time, there is self-locking of the drive motor 3 together with the drive line 4 such that the self-locking is still sufficient to hold the closure element 1 in each intermediate position.

In the preferred embodiment shown in FIGS. 3b & 4, the control link 9 is made symmetrically such that at least two positions of the control link 9, which are equivalent with respect to their action of the control link 9 on the driver 10, are assigned to one position of the driver 10. For the embodiment shown in FIG. 4, this means that the position of the drive element 6 shown is equivalent to the position of the drive element 6 which has been turned by 180°. This is especially advantageous when a complete revolution of the drive element 6 is not necessary for a motorized actuation process. In the embodiment shown in FIG. 4, the motorized actuation process is completed after rotation of the drive element 6 by 180°. The next actuation process can be carried out directly following and without time-consuming free running by the aforementioned symmetry of the drive element 6.

In the embodiment shown in FIG. 4, the control link 9 is also made such that movement of the closure element 1 out of the open position and/or out of the closed position takes place with minimum—preferably no—initial free running between the control link 9 and the driver 10. This is ensured primarily by the configuration of the control surface 18 which, even with the smallest movement of the drive element 6, in FIG. 4 around to the right, causes a corresponding movement of the driven element 7.

In conjunction with the helical configuration of the control link 9, it has already been pointed out that, at least in sections, depending on the angle of rotation of the drive element 6, different transmission ratios can be implemented. This is especially advantageous when a separate closing aid for the tailgate 1 or the like is to be omitted. Then, an especially high driving force or especially high driving moment in the region of the closed position is necessary to draw the tailgate 1 into the completely closed position. The control surface 18 of the control link 9 is made correspondingly flat in this position.

In an especially preferred embodiment, the control link 9 has at least two different link sections, the driver 10 engaging the first link section when the closure element 1 is moved from the open position into the closed position, and the driver 10 engaging the second link section when the closure element 1 is moved from the closed position into the open position. This takes into account the requirement that, during opening or closing, different speeds and/or forces can be required.

In order to simplify the triggering of the drive motor 3 as much as possible, blocking operation is provided for the drive motor 3. This means that when the open position and the closed position are reached, optionally provided blocking elements engage one another and block further motion of the drive motor 3.

In a preferred configuration, blocking operation is implemented when the open position and/or closed position is reached by the drive element 6 engaging the driven element 7 or an element coupled to the driven element 7, by which further movement of the drive element 6, and thus, of the drive motor 3 is blocked.

In the embodiment shown in FIG. 4, on the drive element 6 there are blocking elements 19 which engage the opposing blocking elements 20 on the driven element 7. In the embodiment shown in FIG. 5, conversely, the driver 10 located on the drive element 6 is blocked after completion of motorized movement by the control surface 18b of the control link 9 which is located on the driven element 7.

In blocking operation, it is fundamentally such that, when a blocking current occurs, the voltage applied to the drive motor 3 is turned off. Detection of the blocking current can be recognized and evaluated via known pinch protection algorithms which may be provided and implemented by control engineering. Of course, numerous other possibilities for implementation of blocking operation are conceivable.

It has already been pointed out above that, in addition to a motorized movement capacity, fundamentally, also manual mobility is desired. In certain applications, it can be sufficient to provide this manual movability only for an emergency. In a preferred configuration, it is provided that the driver 10 can be disengaged from the control link 9 by a manual uncoupling movement. In the embodiments shown in FIGS. 4 & 5, this uncoupling movement could consist in the driver 10 being moved perpendicularly to the plane of the drawings out of the control link 9. The sectional view in FIG. 5 shows this schematically by movement from the solid line position of driver 10 to the dash line position thereof.

In the preferred embodiment shown in FIG. 2, a mechanism 3a—drive-side mechanism—is connected to the drive line 4 at a site between the drive motor 3 and the slotted link mechanism 5. Generally, mechanism 3a will be a spur gear. Alternatively or additionally, there can also be a clutch or the like here.

Furthermore, it can be provided that another mechanism—driven-side mechanism—is connected to the drive line 4 at a point between the slotted link mechanism 5 and the closure element 1. Here, this additional driven-side mechanism can be an additional spur gear or preferably a lever mechanism.

According to another teaching which acquires independent importance, the above described drive arrangement has a slotted link mechanism 5 connected to the drive line 4 and the driven element 7 is a pivoting lever which can be pivoted around a driven axis 17. For example, the embodiment shown in FIG. 4 corresponds to this additional teaching.

The limitation of the movement capacity of the driven element 7 essentially perpendicular to the drive axis 8 is not required according to another teaching. Otherwise, all previous statements apply accordingly.

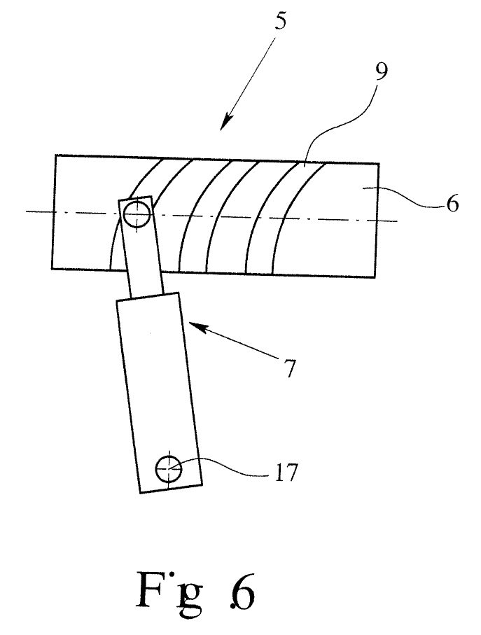

In an especially preferred configuration according to another teaching shown in FIG. 6, it is provided that the drive element 6 is made roller-shaped and on its outer periphery has a control link 9. If the roll is made as a hollow roller, the control link 9 can alternatively or additionally be located on the inner periphery of the roller. Here, the same considerations apply as to the described disk-shaped drive element 6 which has the control link 9 on the two end sides.

It has already been explained that this can have special advantages especially with respect to the required installation space. All the previous statements apply accordingly to this roll-shaped configuration of the drive element 6.

What is claimed is:

1. Drive arrangement for motorized movement of a closure element of a motor vehicle that can be moved between an open position and a closed position, comprising:
at least one drive and drive engineering means for coupling the at least one drive to the closure element, the drive having a drive motor and a drive line connected downstream of the drive motor,
wherein the drive line of the drive comprises a slotted link mechanism,
wherein the slotted link mechanism has a drive element and a driven element,
wherein the drive element is rotatable by means of the drive motor around a drive axis,
wherein the drive element engages the driven element by drive engineering via a control link and a driver which corresponds to the control link, and
wherein the driven element is movable essentially perpendicular to the drive axis by rotation of the drive element.

2. Drive arrangement in accordance with claim 1, wherein a connecting rod is connected to the drive line and one end of the connecting rod being adapted to be coupled eccentrically to the closure element or to the body of the motor vehicle in an installed state of the drive arrangement so that the closure element is able to pivot around a closure element axis.

3. Drive arrangement in accordance with claim 1, wherein the control link is assigned to the drive element and the driver is assigned to the driven element.

4. Drive arrangement in accordance with claim 3, wherein the driven element is moved in a lengthwise direction thereof by the driver.

5. Drive arrangement in accordance with claim 3, wherein the driven element is a pivoting lever which is pivotable around a driven axis, and wherein the driver is located spaced apart from the driven axis on the driven element.

6. Drive arrangement in accordance with claim 3, wherein the drive element is disk-shaped and has a control link on one side.

7. Drive arrangement in accordance with claim 6, wherein the drive element has a control link on both sides.

8. Drive arrangement in accordance with claim 3, wherein the control link is essentially helical around the drive axis.

9. Drive arrangement in accordance with claim 3, wherein the control link is point-symmetric with respect to the drive axis.

10. Drive arrangement in accordance with claim 1, wherein the control link is assigned to the driven element and the driver is assigned to the drive element.

11. Drive arrangement in accordance with claim 10, wherein the driver is located eccentrically on the drive element.

12. Drive arrangement in accordance with claim 10, wherein the driven element is a pivoting lever which is pivotable around a driven axis, and wherein the control link is located in or on the pivoting lever.

13. Drive arrangement in accordance with claim 12, wherein the control link is a recess in the driven element and wherein the driven element is a pivoting lever.

14. Drive arrangement in accordance with claim 1, wherein the control link is one of a crosspiece, a groove, a recess, and a slot on or in the link body.

15. Drive arrangement in accordance with claim 1, wherein the driver is a driver pin.

16. Drive arrangement in accordance with claim 1, wherein the control link, in an installed state of the drive arrangement, is adapted to enable manual movement of the closure element from the open position into the closed position and vice verse without movement of the drive element.

17. Drive arrangement in accordance with claim 1, wherein the control link is symmetrical such that at least two positions of the control link are equivalent with respect to the action of the control link on the driver for a given position of the driver.

18. Drive arrangement in accordance with claim 1, wherein the control link is adapted to enable, in an installed state of the drive arrangement, movement of the closure element into and out of the open position and the closed position with a minimum initial freewheeling between the control link and the driver.

19. Drive arrangement in accordance with claim 1, wherein the control link has sections which produce a different transmission ratio depending on the angle of rotation of the drive element.

20. Drive arrangement in accordance with claim 1, wherein the driver is movable so as to be disengaged from the control link by a manual uncoupling movement for emergency operation.

21. Drive arrangement for motorized movement of a closure element of a motor vehicle that can be moved between an open position and a closed position, comprising:
at least one drive and drive engineering means for coupling the at least one drive to the closure element, the drive having a drive motor and a drive line connected downstream of the drive motor, and
wherein the drive line of the drive comprises a slotted link mechanism,
wherein the slotted link mechanism has a drive element and a driven element,
wherein the drive element is rotatable by means of the drive motor around a drive axis,
wherein the drive element engages the driven element by drive engineering via a control link and a driver which corresponds to the control link, and
wherein the driven element is a pivoting lever which is pivotable around a driven axis.

22. Drive arrangement in accordance with claim 21, wherein one of the drive element and the driven element is roller-shaped and has a control link on its outer periphery

23. Drive arrangement in accordance with claim 21, wherein one of the drive element and the driven element is a hollow roller and has a control link on its inside periphery.

24. Motor vehicle, comprising:
a vehicle body,
a closure element mounted for movement relative to an opening of the vehicle body between an open position and a closed position
a drive arrangement for motorized movement of the closure element between said open position and said closed position, said drive arrangement having at least one drive, drive engineering means for coupling the at least one drive to the closure element, the drive having a drive motor and a drive line connected downstream of the drive motor,
wherein the drive line of the drive comprises a slotted link mechanism,
wherein the slotted link mechanism has a drive element and a driven element,
wherein the drive element is rotatable by means of the drive motor around a drive axis,
wherein the drive element engages the driven element by drive engineering via a control link and a driver which corresponds to the control link, and
wherein the driven element is movable essentially perpendicular to the drive axis by rotation of the drive element.

25. Motor vehicle according to claim 24, wherein a connecting rod is connected to the drive line and one end of the connecting rod is coupled eccentrically to the closure element or to the body of the motor vehicle so that the closure element is pivotable around a closure element axis.

26. Motor vehicle according to claim 24, wherein the control link enables manual movement of the closure element from the open position into the closed position and vice verse without movement of the drive element.

27. Motor vehicle in according to claim 24, wherein the control link enables movement of the closure element into and out of the open position and the closed position with a minimum initial freewheeling between the control link and the driver.

28. Motor vehicle, comprising:
a vehicle body,
a closure element mounted for movement relative to an opening of the vehicle body between an open position and a closed position
a drive arrangement for motorized movement of the closure element between said open position and said closed position, said drive arrangement having at least one drive, drive engineering means for coupling the at least one drive to the closure element, the drive having a drive motor and a drive line connected downstream of the drive motor, and a slotted link mechanism connected to the drive line of the drive,
wherein the drive line of the drive comprises a slotted link mechanism,
wherein the drive element is rotatable by means of the drive motor around a drive axis,
wherein the drive element engages the driven element by drive engineering via a control link and a driver which corresponds to the control link, and
wherein the driven element is a pivoting lever which is pivotable around a driven axis.
